(19) United States
(12) Patent Application Publication
(10) Pub. No.: US 2025/0030473 A1
(43) Pub. Date: Jan. 23, 2025

(54) REFERENCE SIGNAL INDEX AND MACHINE LEARNING FOR BEAM PREDICTION

(71) Applicant: QUALCOMM Incorporated, San Diego, CA (US)

(72) Inventors: Qiaoyu LI, Beijing (CN); Arumugam CHENDAMARAI KANNAN, San Diego, CA (US); Taesang YOO, San Diego, CA (US); Philip Aaron SISK, San Diego, CA (US); Himanshu JOSHI, San Jose, CA (US); Mahmoud TAHERZADEH BOROUJENI, San Diego, CA (US); Tao LUO, San Diego, CA (US)

(21) Appl. No.: 18/707,090

(22) PCT Filed: Jan. 19, 2022
(86) PCT No.: PCT/CN2022/072662

§ 371 Date: May 2, 2024

(51) Int. Cl. H04B 17/318; H04B 7/06; H04W 24/10

(52) U.S. Cl. CPC H04B 17/328; H04B 7/0695; H04W 24/10

(57) ABSTRACT

Various aspects of the present disclosure generally relate to wireless communication. In some aspects, a user equipment (UE) may receive a configuration that includes one or more mapping rules, each of the one or more mapping rules indicating a mapping between one or more reference signal received power (RSRP) measurements, associated with one or more reference signal resources, and one or more indices, associated with one or more feature input vectors for a machine learning model. The UE may initiate a beam prediction based at least in part on the one or more mapping rules. Numerous other aspects are described.

### FIELD OF THE DISCLOSURE

Aspects of the present disclosure generally relate to wireless communication and to techniques and apparatuses for reference signal index and machine learning for beam prediction.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a configuration that includes one or more mapping rules, each of the one or more mapping rules indicating a mapping between one or more reference signal received power (RSRP) measurements, associated with one or more reference signal resources, and one or more indices, associated with one or more feature input vectors for a machine learning model. The method may include initiating a beam prediction based at least in part on the one or more mapping rules.

Some aspects described herein relate to a method of wireless communication performed by a base station. The method may include transmitting a configuration that includes one or more mapping rules, each of the one or more mapping rules indicating a mapping between one or more RSRP measurements, associated with one or more reference signal resources, and one or more indices, associated with one or more feature input vectors for a machine learning model. The method may include receiving an indication of a beam prediction based at least in part on the one or more mapping rules.

Some aspects described herein relate to an apparatus for wireless communication performed by a UE. The apparatus may include a memory and one or more processors, coupled to the memory. The one or more processors may be configured to receive a configuration that includes one or more mapping rules, each of the one or more mapping rules indicating a mapping between one or more RSRP measurements, associated with one or more reference signal resources, and one or more indices, associated with one or more feature input vectors for a machine learning model. The one or more processors may be configured to initiate a beam prediction based at least in part on the one or more mapping rules.

Some aspects described herein relate to an apparatus for wireless communication performed by a base station. The apparatus may include a memory and one or more processors, coupled to the memory. The one or more processors may be configured to transmit a configuration that includes one or more mapping rules, each of the one or more mapping rules indicating a mapping between one or more RSRP measurements, associated with one or more reference signal resources, and one or more indices, associated with one or more feature input vectors for a machine learning model. The one or more processors may be configured to receive an indication of a beam prediction based at least in part on the one or more mapping rules.

Some aspects described herein relate to a non-transitory computer-readable medium that stores a set of instructions for wireless communication by a UE. The set of instructions, when executed by one or more processors of the UE, may cause the UE to receive a configuration that includes one or more mapping rules, each of the one or more mapping rules indicating a mapping between one or more RSRP measurements, associated with one or more reference signal resources, and one or more indices, associated with one or more feature input vectors for a machine learning model. The set of instructions, when executed by one or more processors of the UE, may cause the UE to initiate a beam prediction based at least in part on the one or more mapping rules.

Some aspects described herein relate to a non-transitory computer-readable medium that stores a set of instructions for wireless communication by a base station. The set of instructions, when executed by one or more processors of the base station, may cause the base station to transmit a configuration that includes one or more mapping rules, each of the one or more mapping rules indicating a mapping between one or more RSRP measurements, associated with one or more reference signal resources, and one or more indices, associated with one or more feature input vectors for a machine learning model. The set of instructions, when executed by one or more processors of the base station, may cause the base station to receive an indication of a beam prediction based at least in part on the one or more mapping rules.

Some aspects described herein relate to an apparatus for wireless communication. The apparatus may include means for receiving a configuration that includes one or more mapping rules, each of the one or more mapping rules indicating a mapping between one or more RSRP measurements, associated with one or more reference signal resources, and one or more indices, associated with one or more feature input vectors for a machine learning model. The apparatus may include means for initiating a beam prediction based at least in part on the one or more mapping rules.

Some aspects described herein relate to an apparatus for wireless communication. The apparatus may include means for transmitting a configuration that includes one or more mapping rules, each of the one or more mapping rules indicating a mapping between one or more RSRP measurements, associated with one or more reference signal resources, and one or more indices, associated with one or more feature input vectors for a machine learning model. The apparatus may include means for receiving an indication of a beam prediction based at least in part on the one or more mapping rules.

Aspects generally include a method, apparatus, system, computer program product, non-transitory computer-readable medium, user equipment, base station, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment in a wireless network, in accordance with the present disclosure.

FIG. 3 is a diagram illustrating an example of channel state information reference signal beam management procedures, in accordance with the present disclosure.

FIG. 4 is a diagram illustrating an example of beam management procedures, in accordance with the present disclosure.

FIG. 5 is a diagram illustrating an example of beam change prediction, in accordance with the present disclosure.

FIG. 6 is a diagram illustrating an example of long short-term memory based beam change prediction, in accordance with the present disclosure.

FIG. 7 is a diagram illustrating an example of a generic model for beam prediction, in accordance with the present disclosure.

FIG. 8 is a diagram illustrating an example associated with reference signal index and machine learning for beam prediction, in accordance with the present disclosure.

FIG. 9 is a diagram illustrating an example associated with beam prediction using a machine learning model, in accordance with the present disclosure.

FIG. 10 is a diagram illustrating an example associated with a channel state information report setting based configuration, in accordance with the present disclosure.

FIG. 11 is a diagram illustrating an example associated with a reference signal resource set based configuration, in accordance with the present disclosure.

FIG. 12 is a diagram illustrating an example process associated with reference signal index and machine learning for beam prediction, in accordance with the present disclosure.

FIG. 13 is a diagram illustrating an example process associated with reference signal index and machine learning for beam prediction, in accordance with the present disclosure.

FIG. 14 is a diagram of an example apparatus for wireless communication, in accordance with the present disclosure.

FIG. 15 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

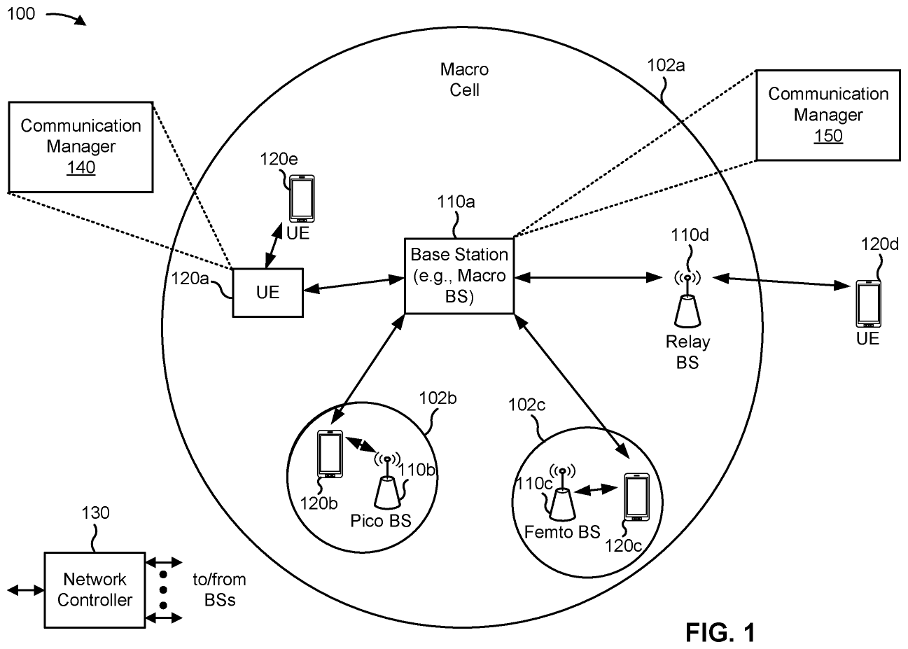

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a configuration that includes one or more mapping rules, each of the one or more mapping rules indicating a mapping between one or more reference signal received power (RSRP) measurements, associated with one or more reference signal resources, and one or more indices, associated with one or more feature input vectors for a machine learning model; and initiate a beam prediction based at least in part on the one or more mapping rules. Additionally, or alternatively, the communication manager 140 may perform one or more other operations described herein.

In some aspects, the base station 110 may include a communication manager 150. As described in more detail elsewhere herein, the communication manager 150 may transmit a configuration that includes one or more mapping rules, each of the one or more mapping rules indicating a mapping between one or more RSRP measurements, associated with one or more reference signal resources, and one or more indices, associated with one or more feature input vectors for a machine learning model; and receive an indication of a beam prediction based at least in part on the one or more mapping rules. Additionally, or alternatively, the communication manager 150 may perform one or more other operations described herein.

As indicated above, FIG. 1 is provided as an example. Other examples may differ from what is described with regard to FIG. 1.

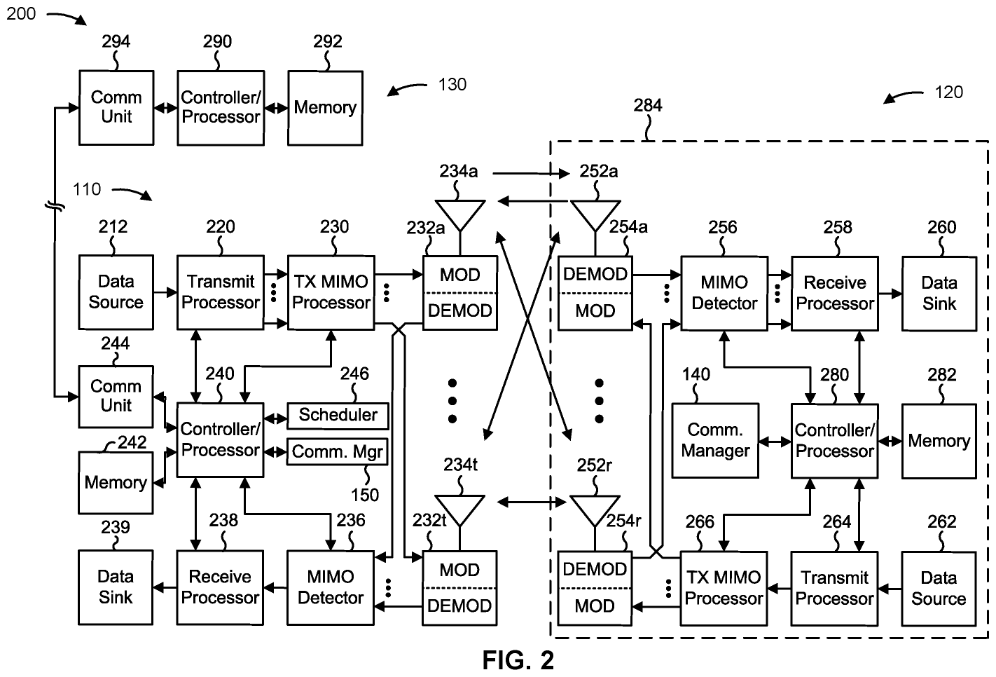

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine an RSRP parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

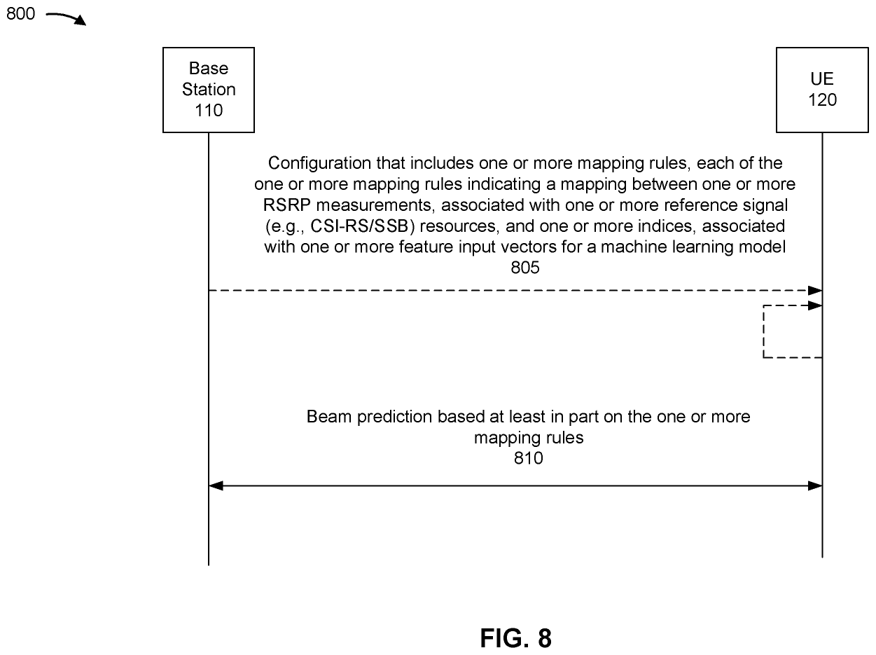

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 8-15).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 8-15).

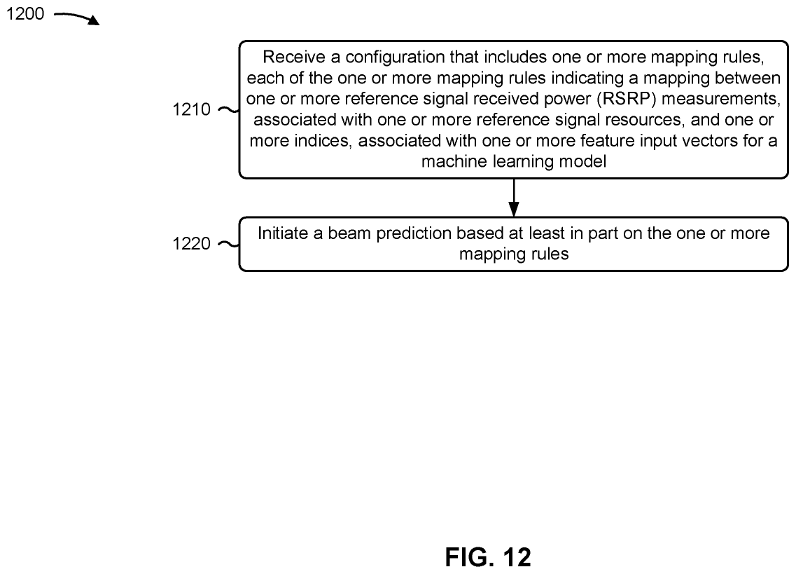

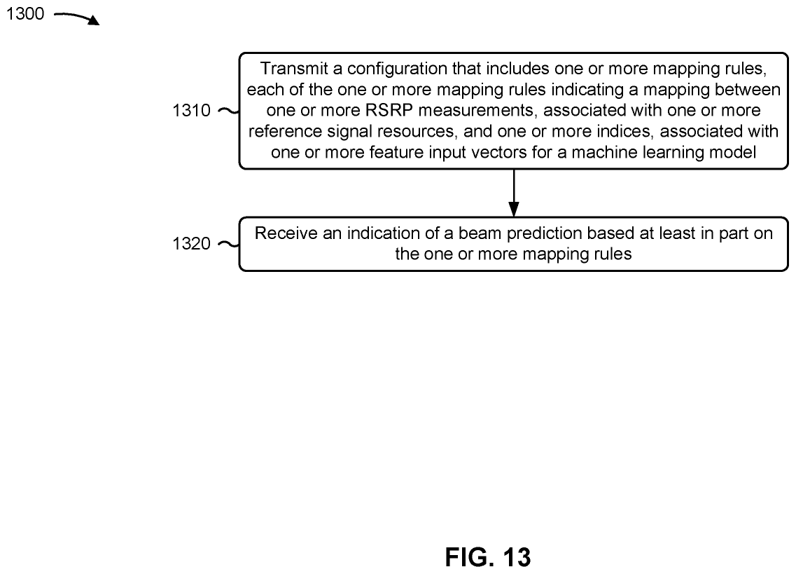

The controller/processor 240 of the base station 110, the controller/processor 280 of the UE 120, and/or any other component(s) of FIG. 2 may perform one or more techniques associated with reference signal index and machine learning for beam prediction, as described in more detail elsewhere herein. For example, the controller/processor 240 of the base station 110, the controller/processor 280 of the UE 120, and/or any other component(s) of FIG. 2 may perform or direct operations of, for example, process 1200 of FIG. 12, process 1300 of FIG. 13, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1200 of FIG. 12, process 1300 of FIG. 13, and/or other processes as described herein. In some examples, executing instructions may include running the instructions, converting the instructions, compiling the instructions, and/or interpreting the instructions, among other examples.

In some aspects, the UE 120 includes means for receiving a configuration that includes one or more mapping rules, each of the one or more mapping rules indicating a mapping between one or more RSRP measurements, associated with one or more reference signal resources, and one or more indices, associated with one or more feature input vectors for a machine learning model; and/or means for initiating a beam prediction based at least in part on the one or more mapping rules. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station 110 includes means for transmitting a configuration that includes one or more mapping rules, each of the one or more mapping rules indicating a mapping between one or more RSRP measurements, associated with one or more reference signal resources, and one or more indices, associated with one or more feature input vectors for a machine learning model; and/or means for receiving an indication of a beam prediction based at least in part on the one or more mapping rules. The means for the base station 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

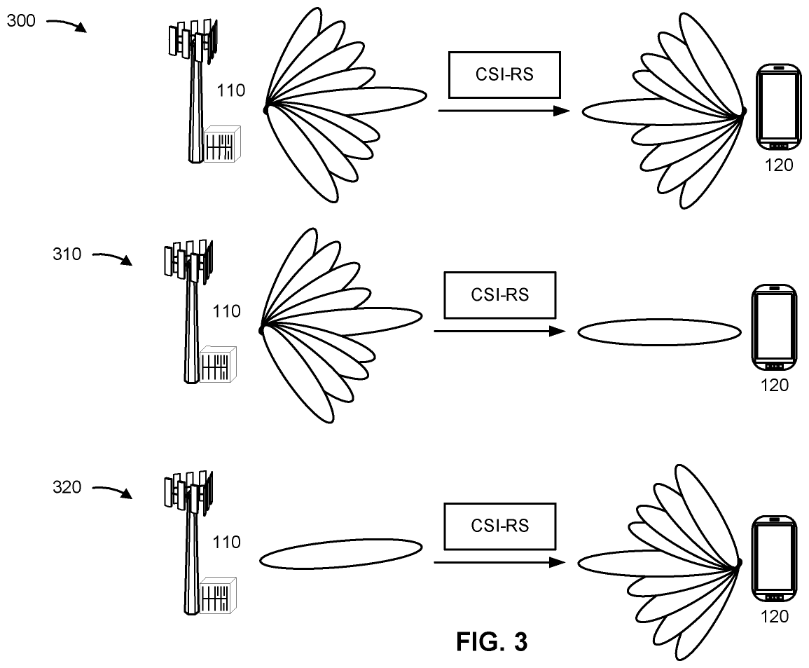

FIG. 3 is a diagram illustrating examples 300, 310, and 320 of channel state information reference signal beam management procedures, in accordance with the present disclosure. As shown in FIG. 3, examples 300, 310, and 320 include a UE 120 in communication with a base station 110 in a wireless network (e.g., wireless network 100). However, the devices shown in FIG. 3 are provided as examples, and the wireless network may support communication and beam management between other devices (e.g., between a UE 120 and a base station 110 or transmit receive point (TRP), between a mobile termination node and a control node, between an integrated access and backhaul (IAB) child node and an IAB parent node, and/or between a scheduled node and a scheduling node). In some aspects, the UE 120 and the base station 110 may be in a connected state (e.g., a radio resource control (RRC) connected state).

As shown in FIG. 3, example 300 may include a base station 110 and a UE 120 communicating to perform beam management using a channel state information (CSI) reference signal (RS) (collectively, CSI-RS), or multiple CSI-RSs. Example 300 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 3 and example 300, CSI-RSs may be configured to be transmitted from the base station 110 to the UE 120. The CSI-RSs may be configured to be periodic (e.g., using RRC signaling), semi-persistent (e.g., using media access control (MAC) control element (MAC-CE) signaling), and/or aperiodic (e.g., using downlink control information (DCI)).

The first beam management procedure may include the base station 110 performing beam sweeping over multiple transmit (Tx) beams. The base station 110 may transmit a CSI-RS using each transmit beam for beam management. To enable the UE 120 to perform receive (Rx) beam sweeping, the base station may use a transmit beam to transmit (e.g., with repetitions) each CSI-RS at multiple times within the same RS resource set so that the UE 120 can sweep through receive beams in multiple transmission instances. For example, if the base station 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the base station 110, the UE 120 may perform beam sweeping through the receive beams of the UE 120. As a result, the first beam management procedure may enable the UE 120 to measure a CSI-RS on different transmit beams using different receive beams to support selection of base station 110 transmit beams/UE 120 receive beam(s) beam pair(s). The UE 120 may report the measurements to the base station 110 to enable the base station 110 to select one or more beam pair(s) for communication between the base station 110 and the UE 120. While example 300 has been described in connection with CSI-RSs, the first beam management process may also use a synchronization signal block (SSB), or multiple SSBs, for beam management in a similar manner as described above.

As shown in FIG. 3, example 310 may include a base station 110 and a UE 120 communicating to perform beam management using CSI-RSs. Example 310 depicts a second beam management procedure (e.g., P2 CSI-RS beam management). The second beam management procedure may be referred to as a beam refinement procedure, a base station beam refinement procedure, a TRP beam refinement procedure, and/or a transmit beam refinement procedure. As shown in FIG. 3 and example 310, CSI-RSs may be configured to be transmitted from the base station 110 to the UE 120. The CSI-RSs may be configured to be aperiodic (e.g., using DCI). The second beam management procedure may include the base station 110 performing beam sweeping over one or more transmit beams. The one or more transmit beams may be a subset of all transmit beams associated with the base station 110 (e.g., determined based at least in part on measurements reported by the UE 120 in connection with the first beam management procedure). The base station 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the base station 110 to select a best transmit beam based at least in part on measurements of the CSI-RSs (e.g., measured by the UE 120 using the single receive beam) reported by the UE 120.

As shown in FIG. 3, example 320 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 3 and example 320, one or more CSI-RSs may be configured to be transmitted from the base station 110 to the UE 120. The CSI-RSs may be configured to be aperiodic (e.g., using DCI). The third beam management process may include the base station 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the base station may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the base station 110 and/or the UE 120 to select a best receive beam based at least in part on reported measurements received from the UE 120 (e.g., of the CSI-RS of the transmit beam using the one or more receive beams).

In some cases, the term “reference signal resources” as used herein may include CSI-RS resources, SSB resources, or both CSI-RS and SSB resources. Additionally, or alternatively, other reference signal resources are considered to be within the scope of the reference signal resources.

As described in more detail below, the UE 120 may perform beam prediction, in accordance with an artificial intelligence or machine learning model, based at least in part on one or more reference signal measurements.

As indicated above, FIG. 3 is provided as an example of beam management procedures. Other examples of beam management procedures may differ from what is described with respect to FIG. 3. For example, the UE 120 and the base station 110 may perform the third beam management procedure before performing the second beam management procedure, and/or the UE 120 and the base station 110 may perform a similar beam management procedure to select a UE transmit beam.

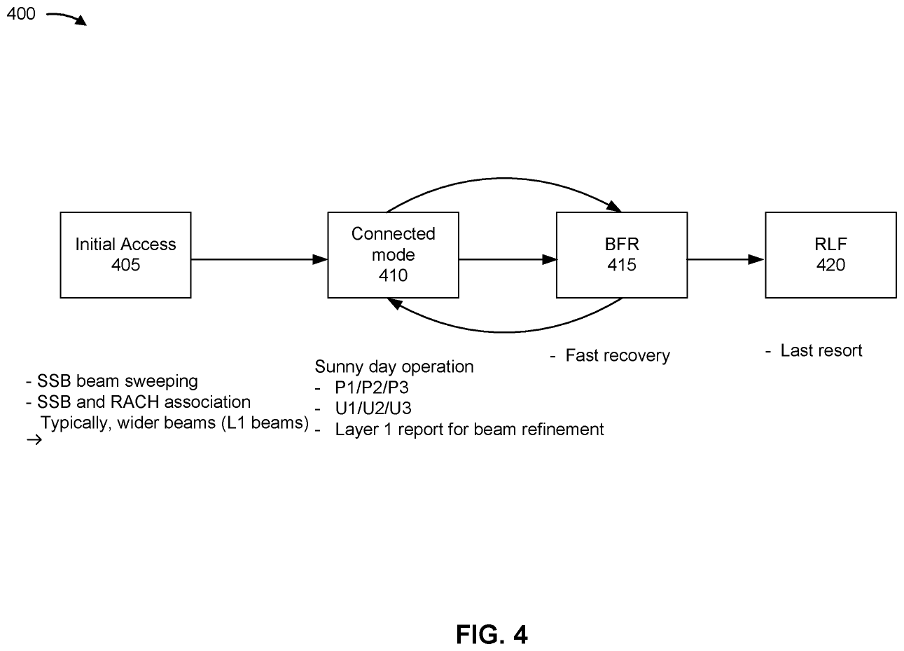

FIG. 4 is a diagram illustrating an example 400 of beam management procedures, in accordance with the present disclosure.

As shown in connection with reference number 405, the UE 120 and the base station 110 may perform an initial access procedure. In some cases, the initial access procedure may include SSB beam switching, or SSB and random access channel (RACH) association (e.g., for wider beams such as L1 beams).

As shown in connection with reference number 410, the UE 120 and the base station 110 may communicate in accordance with a connected mode. For example, the UE 120 or the base station 110 may perform beam management such as downlink beam management (e.g., P1/P2/P3) or uplink beam management (e.g., U1/U2/U3). In some cases, the UE 120 may be configured to generate a Layer 1 report for beam refinement.

As shown in connection with reference number 415, the UE 120 may perform beam failure recovery (BFR). In some cases, beam failure may occur due to changing channel conditions, obstacles, distance from the base station transmitting the beam, or interference, among other examples. When a reference signal for a set of beams fails to satisfy a threshold on a particular number of monitoring occasions, the UE 120 may identify a beam failure, and may perform BFR to recover the beam or identify a new beam for communicating with the base station 110.

As shown in connection with reference number 420, the UE 120 may declare a radio link failure (RLF) based at least in part on the BFR procedure being unsuccessful. In some cases, the UE 120 may declare the RLF after an expiration of a BFR timer (e.g., if the UE 120 has not recovered the beam prior to the expiration of the BFR timer). In some cases, the UE 120 may enter an idle mode, report the RLF, or search for a new cell, among other examples.

As indicated above, FIG. 4 is provided as an example. Other examples may differ from what is described with regard to FIG. 4.

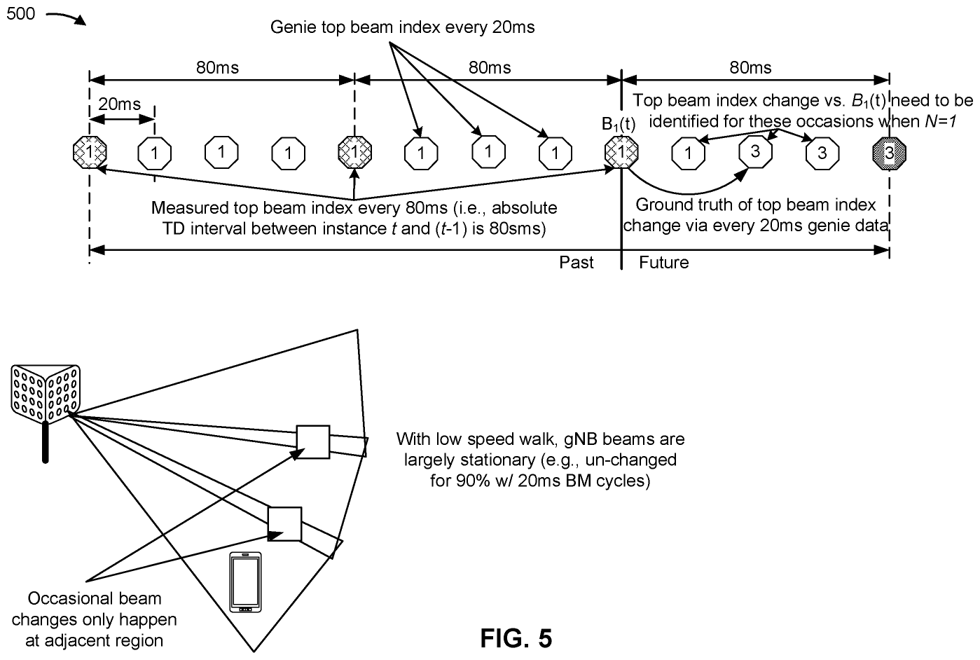

FIG. 5 is a diagram illustrating an example 500 of beam change prediction, in accordance with the present disclosure.

In some cases, beam management (BM) (e.g., frequency BM) with SSB-index-RSRP or CSI-RSRP reporting (e.g., every 20 ms or 40 ms) may consume significant overhead or energy resources of the UE 120. In stationary or low-speed scenarios, the top beam index for the BM may not change over the course of hundreds of milliseconds. As shown in the example 500, in a low speed walk scenario, the beams may be largely stationary (e.g., unchanged for 90% of the time with a 20 ms beam cycle). Thus, it may be beneficial to reduce the overhead or power consumption of the UE 120 by performing one or more of the following:
predicting whether the top beam index may change (or change more

dynamically) at a future time (or a future time window), with increased BM periodicity (e.g., hundreds of milliseconds instead of 20 ms) and/or a reduced number of CSI-RS/SSB resources (e.g., using only four measured beams to predict a top beam out of 32 potential beams); and/or
sending requests (when necessary) to the base station 110 for decreased BM periodicity or increased CSI-RS/SSB resources if the top beam index is predicted to change (or predicted to change more dynamically).

In some cases, the BM procedures with the SSB-index-RSRP or CSI-RSRP reporting may be suspended if the UE 120 identifies a highly stationary condition.

In some cases, the UE 120 may perform long short-term memory (LSTM) based beam prediction, as described in more detail below.

As indicated above, FIG. 5 is provided as an example. Other examples may differ from what is described with regard to FIG. 5.

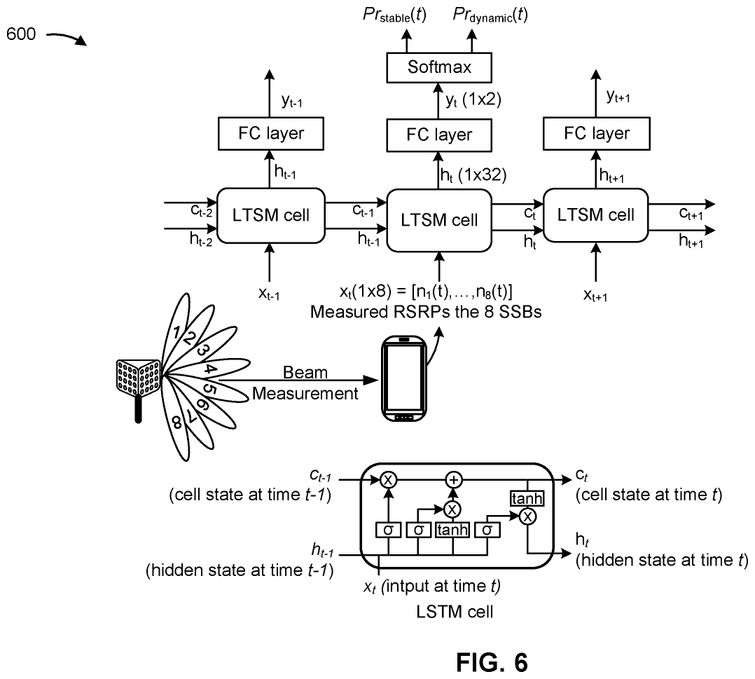

FIG. 6 is a diagram illustrating an example 600 of LSTM based beam change prediction, in accordance with the present disclosure.

In some cases, beam prediction may be based at least in part on an LSTM based beam change prediction model. As shown in the example 600, an input to an LSTM based beam prediction model may include a number of SSB (N_{SSB}) and/or a number of CSI-RS (N_{CSI-RS}) dimension RSRP vectors associated with respective SSB or CSI-RS resources. The associations between the SSB resource indicator (SSBRI) or the CSI-RS reference indicator (CRI), and the index of each input feature, may be pre-defined. The output of the LSTM beam change prediction model may indicate a probability of the two classes.

In some cases, the LSTM beam change prediction model may be trained by the base station 110. Additionally, or alternatively, the LSTM beam change prediction model may be trained by one or more UEs 120. In some cases, the LSTM beam change prediction model may be specific to the UE 120, or may be associated with multiple UEs 120. In some cases, the LSTM beam change prediction model may be specific to the base station 110, or may be associated with multiple base stations 110.

As shown in the example 600, the LSTM cell may receive one or more inputs, such as cₜ−1 (cell state at time t−1), hₜ−1 (hidden state at time t−1), and xₜ (input at time t). An output of the LSTM cell may include cₜ (cell state at time t) and hₜ (hidden state at time t). In some aspects, a beam measurement input may be represented by xₜ(1×8)=[n₁(t), . . . , n₈(t)]. The beam prediction model using the LSTM cell may generate one or more outputs, such as Pr_{stable}(t) and Pr_{dynamic}(t). Additional details of the beam measurement procedure are shown in the figure.

As indicated above, FIG. 6 is provided as an example. Other examples may differ from what is described with regard to FIG. 6.

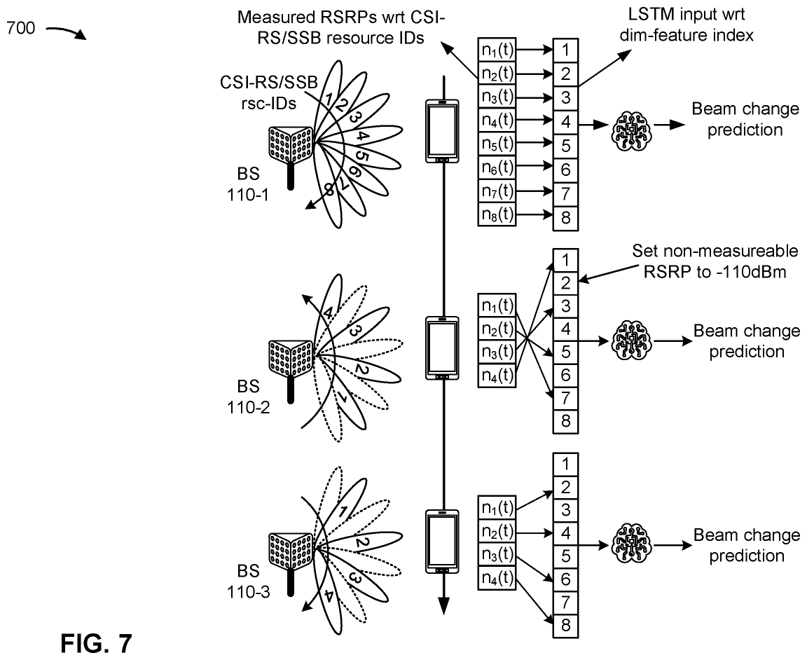

FIG. 7 is a diagram illustrating an example 700 of a generic model for beam prediction, in accordance with the present disclosure.

In some cases, a generic model (e.g., a generic beam prediction model) may be trained for a plurality of base stations 110. For non-measurable beams, an input value for the model may be set to a low value, such as −110 decibels per milliwatt (dBm). In some cases, the LSTM may comprise an 8-dimension input, while the non-measurable inputs may be set to −110 dBm.

As shown in the example 700, the UE 120 (e.g., a vehicle, or a cellphone located within a vehicle) may be moving down a street on which a plurality of base stations 110 are located. The UE 120 may be configured to perform beam measurements based at least in part on a model associated with the base station 110.

In accordance with a first model associated with the first base station 110-1 depicted in FIG. 7, the UE 120 may measure a plurality of beams 1-8. For example, the UE 120 may perform RSRP measurements using one or more reference signal (e.g., CSI-RS/SSB) resources. The UE 120 may map the RSRP measurement associated with a beam, according to one or more mapping rules, to an LSTM input of the machine learning model. For example, the UE 120 may map an RSRP value of the first beam to a first input, an RSRP value of the second beam to a second input, an RSRP value of the third beam to a third input, an RSRP value of the fourth beam to a fourth input, an RSRP value of the fifth beam to a fifth input, an RSRP value of the sixth beam to a sixth input, an RSRP value of the seventh beam to a seventh input, and an RSRP value of the eighth beam to an eighth input. The UE 120 may perform beam prediction (e.g., beam change prediction) for the beams associated with the first base station 110-1 based at least in part on an output of the first model.

In accordance with a second model associated with the second base station 110-2, the UE 120 may measure a plurality of beams (e.g., beams 1-4). The UE 120 may map the RSRP measurement associated with the beam, according to one or more mapping rules, to an LSTM input of the machine learning model. For example, the UE 120 may map an RSRP value of the first beam to a seventh input, an RSRP value of the second beam to a fifth input, an RSRP value of the third beam to a third input, and an RSRP value of the fourth beam to a first input. The UE 120 may perform beam prediction for the beams associated with the second base station 110-2 based at least in part on an output of the second model.

In accordance with a third model associated with the third base station 110-3, the UE 120 may measure a plurality of beams (e.g., beams 1-4). The UE 120 may map the RSRP measurement associated with the beam, according to one or more mapping rules, to an LSTM input of the machine learning model. For example, the UE 120 may map an RSRP value of the first beam to a second input, an RSRP value of the second beam to a fourth input, an RSRP value of the third beam to a sixth input, and an RSRP value of the fourth beam to an eighth input. The UE 120 may perform beam prediction for the beams associated with the third base station 110-3 based at least in part on an output of the third model.

As described above, different base stations 110 may have different reference signal resource identifiers, and associated beam patterns, configured for beam measurements. In some cases, the first base station 110-1 may be associated with a first machine learning model for beam prediction, the second base station 110-2 may be associated with a second machine learning model for beam prediction, and the third base station 110-3 may be associated with a third machine learning model for beam prediction. In order to accurately perform beam prediction for the plurality of base stations 110, the UE 120 may need to be configured with information for each of the individual machine learning models. For example, for each of the machine learning models, the UE 120 may need to be configured with information for how to map the measured RSRPs, associated with the reference signal resource identifiers, to the LSTM input dimension feature indices. Storing the plurality of machine learning models may require a number of storage (e.g., memory) resources of the UE 120. Additionally, determining which model to use, and switching between the plurality of models, may result in latency issues.

Techniques and apparatuses are described herein for reference signal index and machine learning for beam prediction. In some aspects, the UE 120 may receive a configuration that includes one or more mapping rules. Each of the one or more mapping rules may indicate a mapping between one or more RSRP measurements, associated with one or more reference signal resources (e.g., CSI-RS/SSB resources), and one or more indices, associated with one or more feature input vectors for a machine learning model. The UE 120 may initiate a beam prediction procedure based at least in part on the one or more mapping rules.

As described above, configuring the UE 120 with a plurality of machine learning models, for a plurality of base stations 110, may require a number of storage resources of the UE 120. Similarly, using the plurality of machine learning models to perform beam prediction may result in latency. Using the techniques and apparatuses described herein, the UE 120 may be configured with a machine learning model that can be used for beam prediction for a plurality of base stations 110. Thus, the number of storage resources (e.g., memory) and time resources (e.g., latency) needed may be reduced.

As indicated above, FIG. 7 is provided as an example. Other examples may differ from what is described with regard to FIG. 7.

FIG. 8 is a diagram illustrating an example 800 of reference signal index and machine learning for beam prediction, in accordance with the present disclosure. A UE, such as the UE 120, may be configured to communicate with a base station, such as the base station 110.

As shown in connection with reference number 805, the UE 120 may receive a configuration that includes one or more mapping rules. Each of the one or more mapping rules may indicate a mapping between one or more RSRP measurements, associated with one or more reference signal resources (e.g., CSI-RS or SSB resources), and one or more indices, associated with one or more feature input vectors for a machine learning model. In some aspects, the UE 120 may receive the configuration from the base station 110. For example, the UE 120 may receive the configuration via an RRC message. In some aspects, the UE 120 may receive (e.g., obtain) the configuration from a memory of the UE 120. For example, the UE 120 may be pre-configured with the configuration indicating the one or more mapping rules. In some aspects, one or more of the mapping rules may be activated via a MAC-CE or DCI. For example, the base station 110 may transmit, and the UE 120 may receive, a MAC-CE or DCI that indicates to activate one or more of the mapping rules.

In some aspects, the machine learning model may be used for beam prediction. In one example, the machine learning model may output a prediction of the strongest SSBRI or CRI change based at least in part on current and/or previously measured RSRPs associated with the reference signal resources, for a future time window. In another example, the machine learning model may output a prediction of an actual RSRP value associated with at least one of the reference signal resources for a future time window, based at least in part on current and/or previously measured RSRPs associated with the reference signal resources.

In some aspects, the output of the machine learning model may include a beam characteristic or a channel characteristic that is predicted over a time domain, a spatial domain, or a frequency domain. In some aspects, the channel characteristics may include one or more of a Layer 1 RSRP (LI-RSRP), a Layer 1 signal to interference noise ratio (L1-SINR), a precoding matrix indicator (PMI), a rank indicator (RI), a channel quality indicator (CQI), a layer indicator (LI), a power delay profile (PDP), an angle of arrival (AoA), and/or an explicit channel indicator, among other examples.

In some aspects, the machine learning model may be an LSTM model. The LSTM model may receive an input that includes a sequence of measured RSRP vectors measured over a time period. The output of the LSTM model may include the prediction of the strongest SSBRI or CRI change, or the prediction of the actual RSRP value, as described above.

In some aspects, the one or more reference signal resources may be associated with a reference signal resource set (e.g., a CSI-RS or SSB resource set). The reference signal resource set may be associated with a CSI report setting that includes a single mapping rule. In this example, the UE 120 may use the mapping rule to determine the input for beam prediction based at least in part on the reference signal resources associated with the CSI report setting, when the associated CSI report is active. As described above, the mapping rule may be RRC configured, and/or may be updated using a MAC-CE or DCI.

In some aspects, the one or more reference signal resources may be associated with a reference signal resource set (e.g., a CSI-RS or SSB resource set), and the reference signal resource set may be associated with a CSI report setting that includes a plurality of mapping rules.

For periodic CSI reports, a MAC-CE or DCI may be used to activate one or more mapping rules, of the plurality of mapping rules. Otherwise (e.g., if the one or more rules are not activated), the UE 120 may determine that beam prediction is not allowed for the periodic CSI report. In some aspects, a default mapping rule may be configured. In this case, the MAC-CE or DCI may de-activate all rules to indicate that the beam prediction is not allowed for the periodic CSI report.

For semi-persistent CSI reports, the MAC-CE or DCI activating or triggering the CSI report may be used to activate one or more mapping rules, of the plurality of mapping rules. Otherwise (e.g., if the one or more rules are not activated), the UE 120 may determine that beam prediction is not allowed for the semi-persistent CSI report. In some aspects, a default mapping rule may be configured. In this case, the MAC-CE or DCI may de-activate all rules to indicate that the beam prediction is not allowed for the semi-persistent CSI report.

In some aspects, a mapping rule that is currently being used by the UE 120 may be de-activated or released via a MAC-CE or DCI. Additionally, or alternatively, the MAC-CE or DCI may be used to activate or trigger another mapping rule.

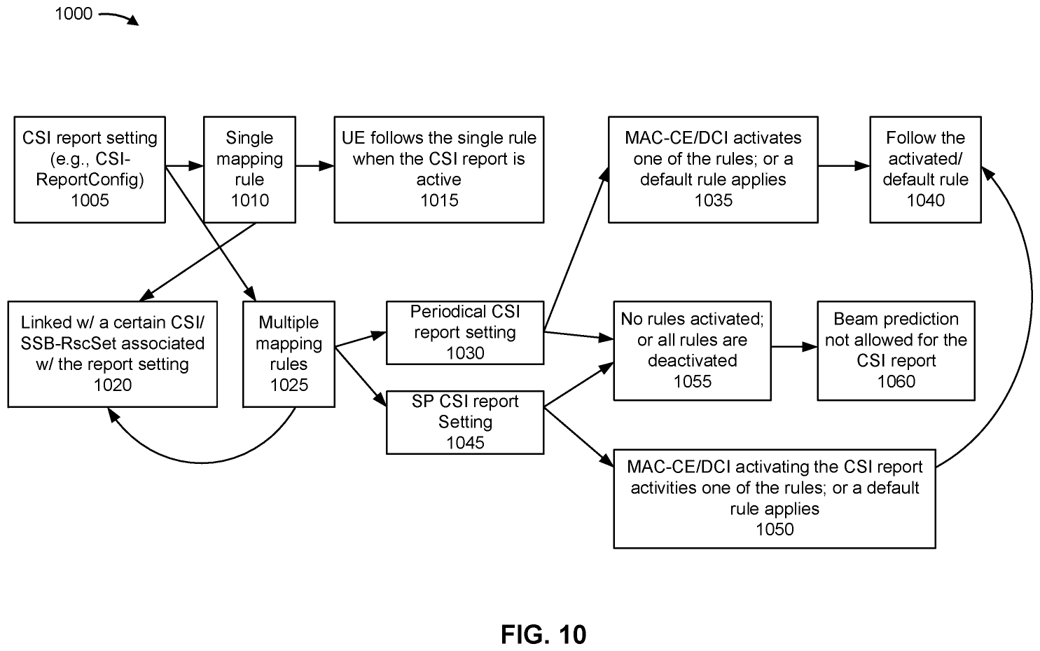

Additional details regarding the CSI report setting based configuration, having a single mapping rule or a plurality of mapping rules, are described below in connection with FIG. 10.

In some aspects, the one or more reference signal resources may be associated with a reference signal resource set (e.g., a CSI-RS or SSB resource set). The reference signal resource set may be configured with single mapping rule for the one or more reference signal resources. In this example, the UE 120 may use the mapping rule to determine the input for beam prediction based at least in part on the reference signal resources associated with the CSI report, when measuring the reference signal resources. As described above, the mapping rule may be RRC configured, and/or may be updated using a MAC-CE or DCI.

In some aspects, the one or more reference signal resources may be associated with a reference signal resource set (e.g., a CSI-RS or SSB resource set), and the reference signal resource set may be configured with a plurality of mapping rules for the one or more reference signal resources.

For a periodic reference signal resource set (e.g., a periodic CSI-RS/SSB resource set), a MAC-CE or DCI may be used to activate one or more mapping rules, of the plurality of mapping rules. Otherwise, the UE 120 may determine that beam prediction is not allowed for the periodic reference signal resource set.

For a semi-persistent reference signal resource set (e.g., semi-persistent CSI-RS), a MAC-CE or DCI may be used to activate one or more mapping rules, of the plurality of mapping rules. Otherwise, the UE 120 may determine that beam prediction is not allowed for the semi-persistent reference signal resource set.

In some aspects, a mapping rule that is currently being used by the UE 120 may be de-activated or released via a MAC-CE or DCI. Additionally, or alternatively, the MAC-CE or DCI may be used to activate or trigger another mapping rule.

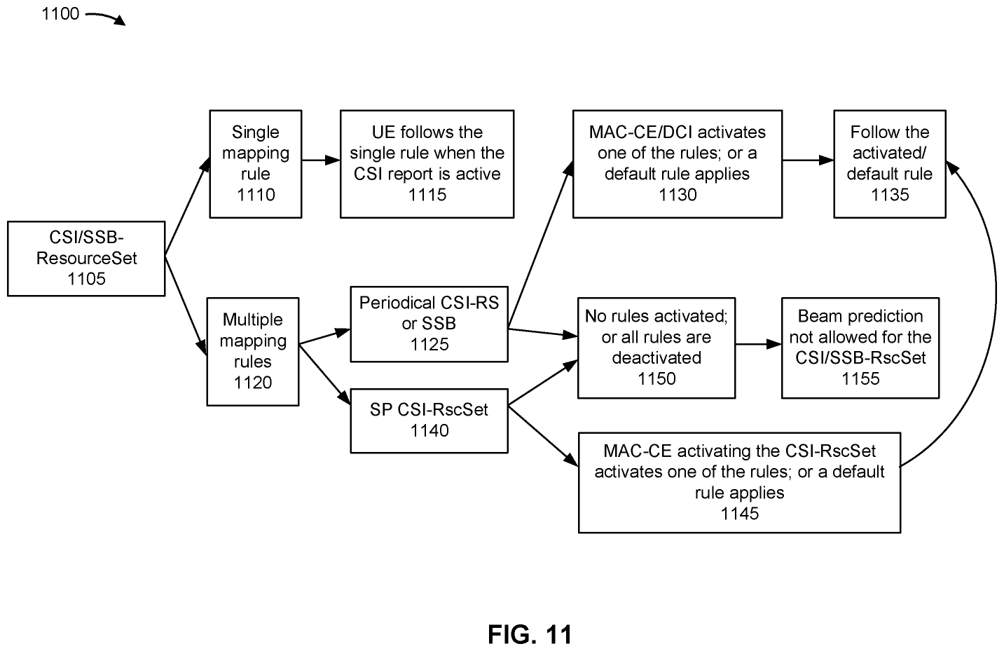

Additional details regarding the reference signal resource set based configuration, having a single mapping rule or a plurality of mapping rules, are described below in connection with FIG. 11.

In some aspects, a resource identifier associated with the reference signal resource may be linked to feature input vectors of the machine learning model. For example, a reference signal resource ID (e.g., a CSI-RS resource ID and/or an SSB resource ID) may be linked to one or more feature input vectors of the machine learning model. In one example, the one or more mapping rules may indicate the reference signal resource ID for each of the feature input vectors. In another example, the one or more mapping rules may indicate the feature input vector for each of the reference signal resource IDs. In another example, the one or more mapping rules may indicate a combinatorial index value that represents the reference signal resource ID for each of the feature input vectors and/or the feature input vector for each of the reference signal resource IDs.

In some aspects, the machine learning model may be an artificial intelligence machine learning model. In some aspects, the machine learning model may be a deep neural network (DNN), or may include a DNN. In some aspects, the machine learning model may be a recurrent neural network (RNN), or may include an RNN, such as an LSTM or a gated recurrent unit (GRU). In some aspects, the machine learning model may be a convolutional neural network (CNN), or may include a CNN.

As shown in connection with reference number 810, the UE 120 may perform beam prediction based at least in part on the one or more mapping rules. For example, the UE 120 may perform one or more beam measurements (e.g., RSRP measurements), map the beam measurements to the feature input vectors of the machine learning model, and perform beam prediction based at least in part on the output of the machine learning model.

As described above, configuring the UE 120 with a plurality of machine learning models, for a plurality of base stations 110, may require a number of storage resources of the UE 120. Similarly, using the plurality of machine learning models to perform beam prediction may result in latency. Using the techniques and apparatuses described herein, the UE 120 may be configured with a machine learning model that can be used for beam prediction for a plurality of base stations 110. Thus, the number of required storage resources (e.g., memory) and time resources may be reduced.

As indicated above, FIG. 8 is provided as an example. Other examples may differ from what is described with regard to FIG. 8.

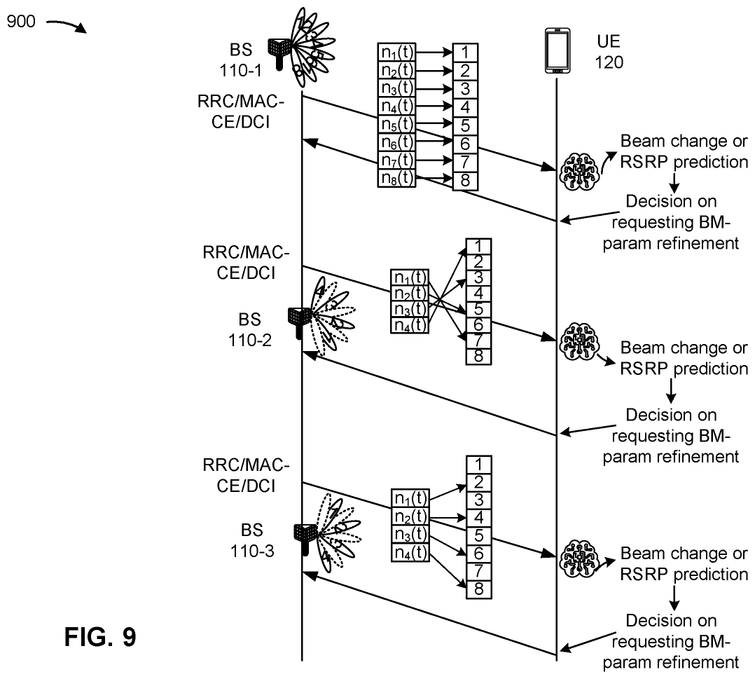

FIG. 9 is a diagram illustrating an example 900 of beam prediction using a machine learning model, in accordance with the present disclosure. As shown in the example 900, the UE 120 may communicate with a plurality of base stations 110 (e.g., while the UE 120 is travelling down a street). The UE 120 may perform beam prediction using a machine learning model that is common to the plurality of base stations 110, or that is common to at least a portion of the base stations 110.

At a first location, the UE 120 may communicate with the first base station 110-1. The first base station 110-1 may activate one or more mapping rules associated with the first base station 110-1, such as via a MAC-CE or DCI. Additionally, or alternatively, the first base station 110-1 may configure the UE 120 with the one or more mapping rules via an RRC message. The UE 120 may perform beam prediction (e.g., RSRP value or beam change prediction) using the machine learning model, and may determine whether or not to request beam management parameter refinement for the beams associated with the first base station 110-1. For example, the UE 120 may determine to request beam management parameter refinement if the beam change is greater than a threshold.

At a second location, the UE 120 may communicate with the second base station 110-2. The second base station 110-2 may activate one or more mapping rules associated with the second base station 110-2, such as via a MAC-CE or DCI. Additionally, or alternatively, the second base station 110-2 may configure the UE 120 with the one or more mapping rules via an RRC message. The UE 120 may perform beam prediction (e.g., RSRP value or beam change prediction) using the machine learning model, and may determine whether or not to request beam management parameter refinement for the beams associated with the second base station 110-2.

At a third location, the UE 120 may communicate with the third base station 110-3. The third base station 110-3 may activate one or more mapping rules associated with the third base station 110-3, such as via a MAC-CE or DCI. Additionally, or alternatively, the third base station 110-3 may configure the UE 120 with the one or more mapping rules via an RRC message. The UE 120 may perform beam prediction (e.g., RSRP value or beam change prediction) using the machine learning model, and may determine whether or not to request beam management parameter refinement for the beams associated with the third base station 110-3.

As described above, the UE 120 may be configured with a machine learning model that can be used for beam prediction for the plurality of base stations 110. Thus, the number of storage (e.g., memory) resources may be reduced, since the UE 120 does not need to store information for each of the individual models associated with the base stations 110. Additionally, the time resources (e.g., latency) may be reduced since the UE 120 does not need to determine which of the plurality of models to use, and to switch between the plurality of models.

As indicated above, FIG. 9 is provided as an example. Other examples may differ from what is described with regard to FIG. 9.

FIG. 10 is a diagram illustrating an example 1000 of a CSI report setting based configuration, in accordance with the present disclosure. In some aspects, one or more reference signal resources may be associated with a reference signal resource set (e.g., a CSI-RS or SSB resource set). The reference signal resource set may be associated with a CSI report setting.

As shown in connection with reference number 1005, the CSI report setting may be indicated by the parameter CSI-ReportConfig.

As shown in connection with reference number 1010, the CSI report setting may include a single mapping rule. As shown in connection with reference number 1015, the UE 120 may follow the single mapping rule. As shown in connection with reference number 1020, the mapping rule may be linked with a certain reference signal resource set associated with the CSI report setting.

As shown in connection with reference number 1025, the CSI report setting may include multiple mapping rules. As shown in connection with reference number 1030, the CSI report setting that includes the multiple mapping rules may be a periodical CSI report setting. As shown in connection with reference number 1035, a mapping rule, of the plurality of mapping rules, may be indicated by a MAC-CE or DCI. Otherwise, a default rule may apply. As shown in connection with reference number 1040, the UE 120 may follow the activated rule. Otherwise, the UE 120 may follow the default rule. As shown in connection with reference number 1045, the CSI report setting that includes the multiple mapping rules may be a semi-persistent CSI report setting. As shown in connection with reference number 1050, a mapping rule, of the plurality of mapping rules, may be indicated by the MAC-CE or DCI that activates the CSI report. Otherwise, a default rule may apply. The UE 120 may follow the activated rule. Otherwise, the UE 120 may follow the default rule. As shown in connection with reference number 1055, for the periodical CSI report setting and/or the semi-persistent CSI report setting, no rules may be activated, or all rules may be de-activated. As shown in connection with reference number 1060, when no rules are activated and/or when all rules are de-activated, beam prediction may not be allowed for the CSI report.

As indicated above, FIG. 10 is provided as an example. Other examples may differ from what is described with regard to FIG. 10.

FIG. 11 is a diagram illustrating an example 1100 of a reference signal resource set based configuration, in accordance with the present disclosure. In some aspects, one or more reference signal resources may be associated with a reference signal resource set (e.g., a CSI-RS or SSB resource set).

As shown in connection with reference number 1105, the reference signal resource set may be indicated by the parameter CSI/SSB-ResourceSet.

As shown in connection with reference number 1110, the resource set may include a single mapping rule. As shown in connection with reference number 1115, the UE 120 may follow the single mapping rule when the CSI report is active.

As shown in connection with reference number 1120, the resource set may include multiple mapping rules. As shown in connection with reference number 1125, the resource set that includes the multiple mapping rules may be a periodical CSI-RS or SSB. As shown in connection with reference number 1130, a mapping rule, of the multiple mapping rules, may be activated by a MAC-CE or DCI. Otherwise, a default rule may apply. As shown in connection with reference number 1135, the UE 120 may follow the activate rule. Otherwise, the UE 120 may follow the default rule. As shown in connection with reference number 1140, the resource set that includes the multiple mapping rules may be a semi-persistent CSI resource set (e.g., CSI-RscSet). As shown in connection with reference number 1145, a mapping rule, of the multiple mapping rules, may be activated by a MAC-CE or DCI that activates the CSI-RscSet. Otherwise, a default rule may apply. As shown in connection with reference number 1150, for the periodical resource set or the semi-persistent CSI resource set, no rules may be activated, or all rules may be de-activated. The UE 120 may follow the activated rule. Otherwise, the UE 120 may follow the default rule. As shown in connection with reference number 1155, when no rules are activated and/or when all rules are de-activated, beam prediction may not be allowed for the reference signal resource set.

As indicated above, FIG. 11 is provided as an example. Other examples may differ from what is described with regard to FIG. 11.

FIG. 12 is a diagram illustrating an example process 1200 performed, for example, by a UE, in accordance with the present disclosure. Example process 1200 is an example where the UE (e.g., UE 120) performs operations associated with reference signal index and machine learning for beam prediction.

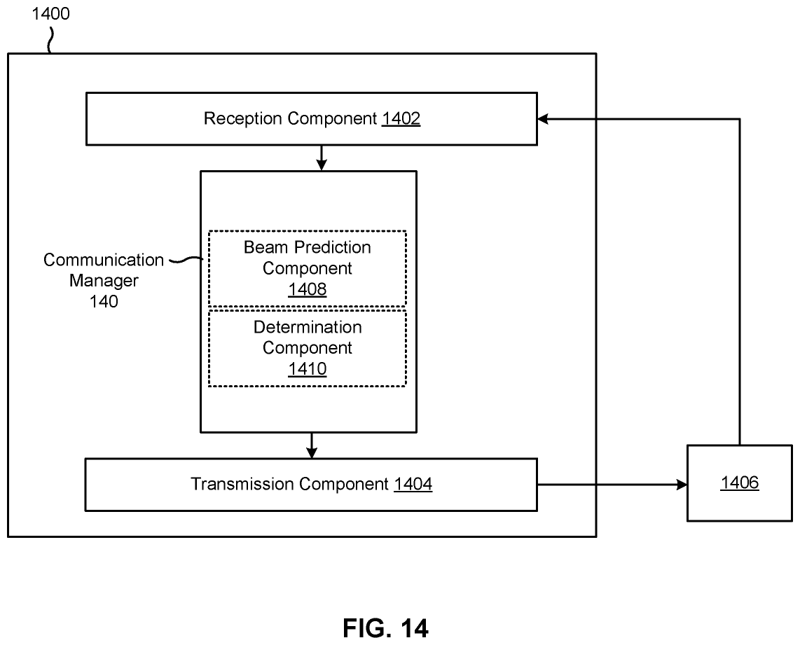

As shown in FIG. 12, in some aspects, process 1200 may include receiving a configuration that includes one or more mapping rules, each of the one or more mapping rules indicating a mapping between one or more RSRP measurements, associated with one or more reference signal resources, and one or more indices, associated with one or more feature input vectors for a machine learning model (block 1210). For example, the UE (e.g., using communication manager 140 and/or reception component 1402, depicted in FIG. 14) may receive a configuration that includes one or more mapping rules, each of the one or more mapping rules indicating a mapping between one or more RSRP measurements, associated with one or more reference signal resources, and one or more indices, associated with one or more feature input vectors for a machine learning model, as described above.

As further shown in FIG. 12, in some aspects, process 1200 may include initiating a beam prediction based at least in part on the one or more mapping rules (block 1220). For example, the UE (e.g., using communication manager 140 and/or beam prediction component 1408, depicted in FIG. 14) may initiate a beam prediction based at least in part on the one or more mapping rules, as described above.

Process 1200 may include additional aspects, such as any single aspect or any combination of aspects described below and/or in connection with one or more other processes described elsewhere herein.

In a first aspect, receiving the configuration comprises receiving a radio resource control message that includes the configuration.

In a second aspect, alone or in combination with the first aspect, receiving the configuration comprises receiving a medium access control message or downlink control information that indicates an update to the configuration.

In a third aspect, alone or in combination with one or more of the first and second aspects, an output of the machine learning model includes at least one of a beam characteristic or a channel characteristic that is predicted over a time domain, a spatial domain, or a frequency domain.

In a fourth aspect, alone or in combination with one or more of the first through third aspects, an output of the machine learning model includes a prediction of a largest reference signal measurement change, associated with the one or more reference signal resources, for a future time period.

In a fifth aspect, alone or in combination with one or more of the first through fourth aspects, the largest reference signal measurement change is based at least in part on one or more current RSRP measurements, or one or more previous RSRP measurements, associated with the one or more reference signal resources.

In a sixth aspect, alone or in combination with one or more of the first through fifth aspects, an output of the machine learning model includes one or more reference signal measurements, associated with the one or more reference signal resources, for a future time window.

In a seventh aspect, alone or in combination with one or more of the first through sixth aspects, the one or more reference signal measurements are based at least in part on one or more current RSRP measurements, or one or more previous RSRP measurements, associated with the one or more reference signal resources.

In an eighth aspect, alone or in combination with one or more of the first through seventh aspects, the machine learning model is an LSTM machine learning model, and an input for the LSTM machine learning model includes a sequence of measured RSRP values.

In a ninth aspect, alone or in combination with one or more of the first through eighth aspects, the one or more reference signal resources are associated with a CSI-RS or SSB resource set, the CSI-RS or SSB resource set is associated with a CSI report setting, and the CSI report setting includes a single mapping rule.

In a tenth aspect, alone or in combination with one or more of the first through ninth aspects, process 1200 includes determining one or more inputs for the beam prediction, based at least in part on the single mapping rule, when a CSI report, associated with the CSI report setting, is active.

In an eleventh aspect, alone or in combination with one or more of the first through tenth aspects, the one or more reference signal resources are associated with a CSI-RS or SSB resource set, the CSI-RS or SSB resource set is associated with a CSI report setting, and the CSI report setting includes a plurality of mapping rules.

In a twelfth aspect, alone or in combination with one or more of the first through eleventh aspects, process 1200 includes receiving an indication, via a medium access control message or downlink control information, of an activated mapping rule, of the plurality of mapping rules, and determining one or more inputs for the beam prediction based at least in part on the activated mapping rule.

In a thirteenth aspect, alone or in combination with one or more of the first through twelfth aspects, process 1200 includes determining one or more inputs for the beam prediction based at least in part on a default mapping rule of the plurality of mapping rules.

In a fourteenth aspect, alone or in combination with one or more of the first through thirteenth aspects, the one or more reference signal resources are associated with a CSI-RS or SSB resource set, and the CSI-RS or SSB resource set is configured with a single mapping rule for the one or more reference signal resources.

In a fifteenth aspect, alone or in combination with one or more of the first through fourteenth aspects, process 1200 includes determining one or more inputs for the beam prediction based at least in part on the single mapping rule.

In a sixteenth aspect, alone or in combination with one or more of the first through fifteenth aspects, the one or more reference signal resources are associated with a CSI-RS or SSB resource set, and the CSI-RS or SSB resource set is configured with a plurality of mapping rules for the one or more reference signal resources.

In a seventeenth aspect, alone or in combination with one or more of the first through sixteenth aspects, process 1200 includes receiving an indication, via a medium access control message or downlink control information, of an activated mapping rule of the plurality of mapping rules, and determining one or more inputs for the beam prediction based at least in part on the activated mapping rule.

In an eighteenth aspect, alone or in combination with one or more of the first through seventeenth aspects, process 1200 includes determining one or more inputs for the beam prediction based at least in part on a default mapping rule of the plurality of mapping rules.

In a nineteenth aspect, alone or in combination with one or more of the first through eighteenth aspects, a mapping rule, of the one or more mapping rules, indicates a reference signal resource identifier for one or more of the feature input vectors, a feature input vector for one or more of the reference signal resource identifiers, or an index value that represents a reference signal resource identifier or a feature input vector.

In a twentieth aspect, alone or in combination with one or more of the first through nineteenth aspects, the machine learning model is based at least in part on a deep neural network, a recurrent neural network, or a convolutional neural network.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a base station, in accordance with the present disclosure. Example process 1300 is an example where the base station (e.g., base station 110) performs operations associated with reference signal index and machine learning for beam prediction.

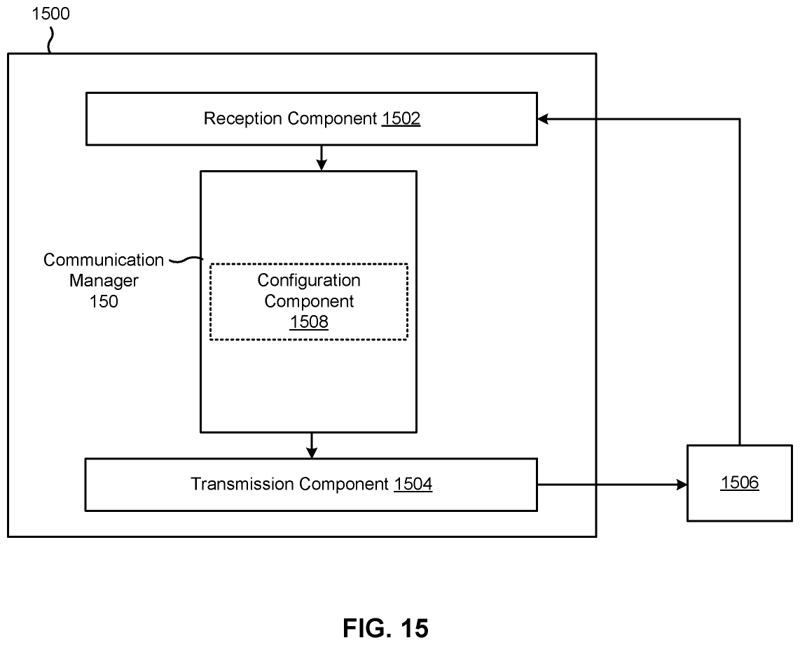

As shown in FIG. 13, in some aspects, process 1300 may include transmitting a configuration that includes one or more mapping rules, each of the one or more mapping rules indicating a mapping between one or more RSRP measurements, associated with one or more reference signal resources, and one or more indices, associated with one or more feature input vectors for a machine learning model (block 1310). For example, the base station (e.g., using communication manager 150 and/or transmission component 1504, depicted in FIG. 15) may transmit a configuration that includes one or more mapping rules, each of the one or more mapping rules indicating a mapping between one or more RSRP measurements, associated with one or more reference signal resources, and one or more indices, associated with one or more feature input vectors for a machine learning model, as described above.

As further shown in FIG. 13, in some aspects, process 1300 may include receiving an indication of a beam prediction based at least in part on the one or more mapping rules (block 1320). For example, the base station (e.g., using communication manager 150 and/or reception component 1502, depicted in FIG. 15) may receive an indication of a beam prediction based at least in part on the one or more mapping rules, as described above.

Process 1300 may include additional aspects, such as any single aspect or any combination of aspects described below and/or in connection with one or more other processes described elsewhere herein.

In a first aspect, transmitting the configuration comprises transmitting a radio resource control message that includes the configuration.

In a second aspect, alone or in combination with the first aspect, transmitting the configuration comprises transmitting a medium access control message or downlink control information that indicates an update to the configuration.

In a third aspect, alone or in combination with one or more of the first and second aspects, an output of the machine learning model includes at least one of a beam characteristic or a channel characteristic that is predicted over a time domain, a spatial domain, or a frequency domain.

In a fourth aspect, alone or in combination with one or more of the first through third aspects, an output of the machine learning model includes a prediction of a largest reference signal measurement change, associated with the one or more reference signal resources, for a future time period.

In a fifth aspect, alone or in combination with one or more of the first through fourth aspects, the largest reference signal measurement change is based at least in part on one or more current RSRP measurements, or one or more previous RSRP measurements, associated with the one or more reference signal resources.

In a sixth aspect, alone or in combination with one or more of the first through fifth aspects, an output of the machine learning model includes one or more reference signal measurements, associated with the one or more reference signal resources, for a future time window.

In a seventh aspect, alone or in combination with one or more of the first through sixth aspects, the one or more reference signal measurements are based at least in part on one or more current RSRP measurements, or one or more previous RSRP measurements, associated with the one or more reference signal resources.

In an eighth aspect, alone or in combination with one or more of the first through seventh aspects, the machine learning model is an LSTM machine learning model, and an input for the LSTM machine learning model includes a sequence of measured RSRP values.

In a ninth aspect, alone or in combination with one or more of the first through eighth aspects, the one or more reference signal resources are associated with a CSI-RS or SSB resource set, the CSI-RS or SSB resource set is associated with a CSI report setting, and the CSI report setting includes a single mapping rule.

In a tenth aspect, alone or in combination with one or more of the first through ninth aspects, process 1300 includes receiving an indication of one or more inputs for the beam prediction, based at least in part on the single mapping rule, when a CSI report, associated with the CSI report setting, is active.

In an eleventh aspect, alone or in combination with one or more of the first through tenth aspects, the one or more reference signal resources are associated with a CSI-RS or SSB resource set, the CSI-RS or SSB resource set is associated with a CSI report setting, and the CSI report setting includes a plurality of mapping rules.

In a twelfth aspect, alone or in combination with one or more of the first through eleventh aspects, process 1300 includes transmitting an indication, via a medium access control message or downlink control information, of an activated mapping rule, of the plurality of mapping rules, and receiving an indication of one or more inputs for the beam prediction based at least in part on the activated mapping rule.

In a thirteenth aspect, alone or in combination with one or more of the first through twelfth aspects, process 1300 includes receiving an indication of one or more inputs for the beam prediction based at least in part on a default mapping rule of the plurality of mapping rules.

In a fourteenth aspect, alone or in combination with one or more of the first through thirteenth aspects, the one or more reference signal resources are associated with a CSI-RS or SSB resource set, and the CSI-RS or SSB resource set is configured with a single mapping rule for the one or more reference signal resources.

In a fifteenth aspect, alone or in combination with one or more of the first through fourteenth aspects, process 1300 includes receiving an indication of one or more inputs for the beam prediction based at least in part on the single mapping rule.

In a sixteenth aspect, alone or in combination with one or more of the first through fifteenth aspects, the one or more reference signal resources are associated with a CSI-RS or SSB resource set, and the CSI-RS or SSB resource set is configured with a plurality of mapping rules for the one or more reference signal resources.

In a seventeenth aspect, alone or in combination with one or more of the first through sixteenth aspects, process 1300 includes transmitting an indication, via a medium access control message or downlink control information, of an activated mapping rule of the plurality of mapping rules, and receiving an indication of one or more inputs for the beam prediction based at least in part on the activated mapping rule.

In an eighteenth aspect, alone or in combination with one or more of the first through seventeenth aspects, process 1300 includes receiving an indication of one or more inputs for the beam prediction based at least in part on a default mapping rule of the plurality of mapping rules.

In a nineteenth aspect, alone or in combination with one or more of the first through eighteenth aspects, a mapping rule, of the one or more mapping rules, indicates a reference signal resource identifier for one or more of the feature input vectors, a feature input vector for one or more of the reference signal resource identifiers, or an index value that represents a reference signal resource identifier or a feature input vector.

In a twentieth aspect, alone or in combination with one or more of the first through nineteenth aspects, the machine learning model is based at least in part on a deep neural network, a recurrent neural network, or a convolutional neural network.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication. The apparatus 1400 may be a UE, or a UE may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 140. The communication manager 140 may include one or more of a beam prediction component 1408, or a determination component 1410, among other examples.

In some aspects, the apparatus 1400 may be configured to perform one or more operations described herein in connection with FIGS. 8-11. Additionally, or alternatively, the apparatus 1400 may be configured to perform one or more processes described herein, such as process 1200 of FIG. 12. In some aspects, the apparatus 1400 and/or one or more components shown in FIG. 14 may include one or more components of the UE described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the UE described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the UE described in connection with FIG. 2. In some aspects, the transmission component 1404 may be co-located with the reception component 1402 in a transceiver.

The reception component 1402 may receive a configuration that includes one or more mapping rules, each of the one or more mapping rules indicating a mapping between one or more RSRP measurements, associated with one or more reference signal resources, and one or more indices, associated with one or more feature input vectors for a machine learning model. The beam prediction component 1408 may initiate a beam prediction based at least in part on the one or more mapping rules.

The determination component 1410 may determine one or more inputs for the beam prediction, based at least in part on the single mapping rule, when a CSI report, associated with the CSI report setting, is active.

The reception component 1402 may receive an indication, via a medium access control message or downlink control information, of an activated mapping rule, of the plurality of mapping rules.

The determination component 1410 may determine one or more inputs for the beam prediction based at least in part on the activated mapping rule.

The determination component 1410 may determine one or more inputs for the beam prediction based at least in part on a default mapping rule of the plurality of mapping rules.

The determination component 1410 may determine one or more inputs for the beam prediction based at least in part on the single mapping rule.

The reception component 1402 may receive an indication, via a medium access control message or downlink control information, of an activated mapping rule of the plurality of mapping rules.

The determination component 1410 may determine one or more inputs for the beam prediction based at least in part on the activated mapping rule.

The determination component 1410 may determine one or more inputs for the beam prediction based at least in part on a default mapping rule of the plurality of mapping rules.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication. The apparatus 1500 may be a base station, or a base station may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 150. The communication manager 150 may include a configuration component 1508, among other examples.

In some aspects, the apparatus 1500 may be configured to perform one or more operations described herein in connection with FIGS. 8-11. Additionally, or alternatively, the apparatus 1500 may be configured to perform one or more processes described herein, such as process 1300 of FIG. 13. In some aspects, the apparatus 1500 and/or one or more components shown in FIG. 15 may include one or more components of the base station described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the base station described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the base station described in connection with FIG. 2. In some aspects, the transmission component 1504 may be co-located with the reception component 1502 in a transceiver.

The transmission component 1504 may transmit a configuration that includes one or more mapping rules, each of the one or more mapping rules indicating a mapping between one or more RSRP measurements, associated with one or more reference signal resources, and one or more indices, associated with one or more feature input vectors for a machine learning model. The reception component 1502 may receive an indication of a beam prediction based at least in part on the one or more mapping rules.

The configuration component 1508 may determine a configuration for the UE 120. For example, the configuration component 1508 may determine the one or more mapping rules for the RSRP measurements, and the one or more indices associated with the feature input vectors for the machine learning model, among other examples.

The reception component 1502 may receive an indication of one or more inputs for the beam prediction, based at least in part on the single mapping rule, when a CSI report, associated with the CSI report setting, is active.

The transmission component 1504 may transmit an indication, via a medium access control message or downlink control information, of an activated mapping rule, of the plurality of mapping rules.

The reception component 1502 may receive an indication of one or more inputs for the beam prediction based at least in part on the activated mapping rule.

The reception component 1502 may receive an indication of one or more inputs for the beam prediction based at least in part on a default mapping rule of the plurality of mapping rules.

The reception component 1502 may receive an indication of one or more inputs for the beam prediction based at least in part on the single mapping rule.

The transmission component 1504 may transmit an indication, via a medium access control message or downlink control information, of an activated mapping rule of the plurality of mapping rules.

The reception component 1502 may receive an indication of one or more inputs for the beam prediction based at least in part on the activated mapping rule.

The reception component 1502 may receive an indication of one or more inputs for the beam prediction based at least in part on a default mapping rule of the plurality of mapping rules.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by a user equipment (UE), comprising: receiving a configuration that includes one or more mapping rules, each of the one or more mapping rules indicating a mapping between one or more reference signal received power (RSRP) measurements, associated with one or more reference signal resources, and one or more indices, associated with one or more feature input vectors for a machine learning model; and initiating a beam prediction based at least in part on the one or more mapping rules.

Aspect 2: The method of Aspect 1, wherein the receiving the configuration comprises receiving a radio resource control message that includes the configuration.

Aspect 3: The method of any of Aspects 1-2, wherein receiving the configuration comprises receiving a medium access control message or downlink control information that indicates an update to the configuration.

Aspect 4: The method of any of Aspects 1-3, wherein an output of the machine learning model includes at least one of a beam characteristic or a channel characteristic that is predicted over a time domain, a spatial domain, or a frequency domain.

Aspect 5: The method of any of Aspects 1-4, wherein an output of the machine learning model includes a prediction of a largest reference signal measurement change, associated with the one or more reference signal resources, for a future time period.

Aspect 6: The method of Aspect 5, wherein the largest reference signal measurement change is based at least in part on one or more current RSRP measurements, or one or more previous RSRP measurements, associated with the one or more reference signal resources.

Aspect 7: The method of any of Aspects 1-6, wherein an output of the machine learning model includes one or more reference signal measurements, associated with the one or more reference signal resources, for a future time window.

Aspect 8: The method of Aspect 7, wherein the one or more reference signal measurements are based at least in part on one or more current RSRP measurements, or one or more previous RSRP measurements, associated with the one or more reference signal resources.

Aspect 9: The method of any of Aspects 1-8, wherein the machine learning model is a long short term memory (LSTM) machine learning model, and wherein an input for the LSTM machine learning model includes a sequence of measured RSRP values.

Aspect 10: The method of any of Aspects 1-9, wherein the one or more reference signal resources are associated with a channel state information (CSI) reference signal (CSI-RS) or synchronization signal block (SSB) resource set, the CSI-RS or SSB resource set is associated with a CSI report setting, and the CSI report setting includes a single mapping rule.

Aspect 11: The method of Aspect 10, further comprising determining one or more inputs for the beam prediction, based at least in part on the single mapping rule, when a CSI report, associated with the CSI report setting, is active.

Aspect 12: The method of any of Aspects 1-11, wherein the one or more reference signal resources are associated with a channel state information (CSI) reference signal (CSI-RS) or synchronization signal block (SSB) resource set, the CSI-RS or SSB resource set is associated with a CSI report setting, and the CSI report setting includes a plurality of mapping rules.

Aspect 13: The method of Aspect 12, further comprising: receiving an indication, via a medium access control message or downlink control information, of an activated mapping rule, of the plurality of mapping rules; and determining one or more inputs for the beam prediction based at least in part on the activated mapping rule.

Aspect 14: The method of Aspect 12, further comprising determining one or more inputs for the beam prediction based at least in part on a default mapping rule of the plurality of mapping rules.

Aspect 15: The method of any of Aspects 1-14, wherein the one or more reference signal resources are associated with a channel state information (CSI) reference signal (CSI-RS) or synchronization signal block (SSB) resource set, and the CSI-RS or SSB resource set is configured with a single mapping rule for the one or more reference signal resources.

Aspect 16: The method of Aspect 15, further comprising determining one or more inputs for the beam prediction based at least in part on the single mapping rule.

Aspect 17: The method of any of Aspects 1-16, wherein the one or more reference signal resources are associated with a channel state information (CSI) reference signal (CSI-RS) or synchronization signal block (SSB) resource set, and the CSI-RS or SSB resource set is configured with a plurality of mapping rules for the one or more reference signal resources.

Aspect 18: The method of Aspect 17, further comprising: receiving an indication, via a medium access control message or downlink control information, of an activated mapping rule of the plurality of mapping rules; and determining one or more inputs for the beam prediction based at least in part on the activated mapping rule.

Aspect 19: The method of Aspect 17, further comprising determining one or more inputs for the beam prediction based at least in part on a default mapping rule of the plurality of mapping rules.

Aspect 20: The method of any of Aspects 1-19, wherein a mapping rule, of the one or more mapping rules, indicates a reference signal resource identifier for one or more of the feature input vectors, a feature input vector for one or more of the reference signal resource identifiers, or an index value that represents a reference signal resource identifier or a feature input vector.

Aspect 21: The method of any of Aspects 1-20, wherein the machine learning model is based at least in part on a deep neural network, a recurrent neural network, or a convolutional neural network.

Aspect 22: A method of wireless communication performed by a base station, comprising: transmitting a configuration that includes one or more mapping rules, each of the one or more mapping rules indicating a mapping between one or more reference signal received power (RSRP) measurements, associated with one or more reference signal resources, and one or more indices, associated with one or more feature input vectors for a machine learning model; and receiving an indication of a beam prediction based at least in part on the one or more mapping rules.

Aspect 23: The method of Aspect 22, wherein the transmitting the configuration comprises transmitting a radio resource control message that includes the configuration.

Aspect 24: The method of any of Aspects 22-23, wherein transmitting the configuration comprises transmitting a medium access control message or downlink control information that indicates an update to the configuration.

Aspect 25: The method of any of Aspects 22-24, wherein an output of the machine learning model includes at least one of a beam characteristic or a channel characteristic that is predicted over a time domain, a spatial domain, or a frequency domain.

Aspect 26: The method of any of Aspects 22-25, wherein an output of the machine learning model includes a prediction of a largest reference signal measurement change, associated with the one or more reference signal resources, for a future time period.

Aspect 27: The method of Aspect 26, wherein the largest reference signal measurement change is based at least in part on one or more current RSRP measurements, or one or more previous RSRP measurements, associated with the one or more reference signal resources.

Aspect 28: The method of any of Aspects 22-27, wherein an output of the machine learning model includes one or more reference signal measurements, associated with the one or more reference signal resources, for a future time window.

Aspect 29: The method of Aspect 28, wherein the one or more reference signal measurements are based at least in part on one or more current RSRP measurements, or one or more previous RSRP measurements, associated with the one or more reference signal resources.

Aspect 30: The method of any of Aspects 22-29, wherein the machine learning model is a long short term memory (LSTM) machine learning model, and wherein an input for the LSTM machine learning model includes a sequence of measured RSRP values.

Aspect 31: The method of any of Aspects 22-30, wherein the one or more reference signal resources are associated with a channel state information (CSI) reference signal (CSI-RS) or synchronization signal block (SSB) resource set, the CSI-RS or SSB resource set is associated with a CSI report setting, and the CSI report setting includes a single mapping rule.

Aspect 32: The method of Aspect 31, further comprising receiving an indication of one or more inputs for the beam prediction, based at least in part on the single mapping rule, when a CSI report, associated with the CSI report setting, is active.

Aspect 33: The method of any of Aspects 22-32, wherein the one or more reference signal resources are associated with a channel state information (CSI) reference signal (CSI-RS) or synchronization signal block (SSB) resource set, the CSI-RS or SSB resource set is associated with a CSI report setting, and the CSI report setting includes a plurality of mapping rules.

Aspect 34: The method of Aspect 33, further comprising: transmitting an

indication, via a medium access control message or downlink control information, of an activated mapping rule, of the plurality of mapping rules; and receiving an indication of one or more inputs for the beam prediction based at least in part on the activated mapping rule.

Aspect 35: The method of Aspect 33, further comprising receiving an indication of one or more inputs for the beam prediction based at least in part on a default mapping rule of the plurality of mapping rules.

Aspect 36: The method of any of Aspects 22-35, wherein the one or more reference signal resources are associated with a channel state information (CSI) reference signal (CSI-RS) or synchronization signal block (SSB) resource set, and the CSI-RS or SSB resource set is configured with a single mapping rule for the one or more reference signal resources.

Aspect 37: The method of Aspect 36, further comprising receiving an indication of one or more inputs for the beam prediction based at least in part on the single mapping rule.

Aspect 38: The method of any of Aspects 22-37, wherein the one or more reference signal resources are associated with a channel state information (CSI) reference signal (CSI-RS) or synchronization signal block (SSB) resource set, and the CSI-RS or SSB resource set is configured with a plurality of mapping rules for the one or more reference signal resources.

Aspect 39: The method of Aspect 38, further comprising: transmitting an indication, via a medium access control message or downlink control information, of an activated mapping rule of the plurality of mapping rules; and receiving an indication of one or more inputs for the beam prediction based at least in part on the activated mapping rule.

Aspect 40: The method of Aspect 38, further comprising receiving an indication of one or more inputs for the beam prediction based at least in part on a default mapping rule of the plurality of mapping rules.

Aspect 41: The method of any of Aspects 22-40, wherein a mapping rule, of the one or more mapping rules, indicates a reference signal resource identifier for one or more of the feature input vectors, a feature input vector for one or more of the reference signal resource identifiers, or an index value that represents a reference signal resource identifier or a feature input vector.

Aspect 42: The method of any of Aspects 22-41, wherein the machine learning model is based at least in part on a deep neural network, a recurrent neural network, or a convolutional neural network.

Aspect 43: An apparatus for wireless communication at a device, comprising a processor; memory coupled with the processor; and instructions stored in the memory and executable by the processor to cause the apparatus to perform the method of one or more of Aspects 1-21.

Aspect 44: A device for wireless communication, comprising a memory and one or more processors coupled to the memory, the one or more processors configured to perform the method of one or more of Aspects 1-21.

Aspect 45: An apparatus for wireless communication, comprising at least one means for performing the method of one or more of Aspects 1-21.

Aspect 46: A non-transitory computer-readable medium storing code for wireless communication, the code comprising instructions executable by a processor to perform the method of one or more of Aspects 1-21.

Aspect 47: A non-transitory computer-readable medium storing a set of instructions for wireless communication, the set of instructions comprising one or more instructions that, when executed by one or more processors of a device, cause the device to perform the method of one or more of Aspects 1-21.

Aspect 48: An apparatus for wireless communication at a device, comprising a processor; memory coupled with the processor; and instructions stored in the memory and executable by the processor to cause the apparatus to perform the method of one or more of Aspects 22-42.

Aspect 49: A device for wireless communication, comprising a memory and one or more processors coupled to the memory, the one or more processors configured to perform the method of one or more of Aspects 22-42.

Aspect 50: An apparatus for wireless communication, comprising at least one means for performing the method of one or more of Aspects 22-42.

Aspect 51: A non-transitory computer-readable medium storing code for wireless communication, the code comprising instructions executable by a processor to perform the method of one or more of Aspects 22-42.

Aspect 52: A non-transitory computer-readable medium storing a set of instructions for wireless communication, the set of instructions comprising one or more instructions that, when executed by one or more processors of a device, cause the device to perform the method of one or more of Aspects 22-42.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive a configuration that includes one or more mapping rules, each of the one or more mapping rules indicating a mapping between one or more reference signal received power (RSRP) measurements, associated with one or more reference signal resources, and one or more indices, associated with one or more feature input vectors for a machine learning model; and
initiate a beam prediction based at least in part on the one or more mapping rules.

2. The apparatus of claim 1, wherein the one or more processors are further configured to receive a radio resource control message that includes the configuration.

3. The apparatus of claim 1, wherein the one or more processors are configured to receive a medium access control message or downlink control information that indicates an update to the configuration.

4. The apparatus of claim 1, wherein an output of the machine learning model includes at least one of a beam characteristic or a channel characteristic that is predicted over a time domain, a spatial domain, or a frequency domain.

5. The apparatus of claim 1, wherein an output of the machine learning model includes a prediction of a largest reference signal measurement change, associated with the one or more reference signal resources, for a future time period.

6. The apparatus of claim 1, wherein an output of the machine learning model includes one or more reference signal measurements, associated with the one or more reference signal resources, for a future time window.

7. The apparatus of claim 1, wherein the machine learning model is a long short term memory (LSTM) machine learning model, and wherein an input for the LSTM machine learning model includes a sequence of measured RSRP values.

8. The apparatus of claim 1, wherein the one or more reference signal resources are associated with a channel state information (CSI) reference signal (CSI-RS) or synchronization signal block (SSB) resource set, the CSI-RS or SSB resource set is associated with a CSI report setting, and the CSI report setting includes a single mapping rule.

9. The apparatus of claim 1, wherein the one or more reference signal resources are associated with a channel state information (CSI) reference signal (CSI-RS) or synchronization signal block (SSB) resource set, the CSI-RS or SSB resource set is associated with a CSI report setting, and the CSI report setting includes a plurality of mapping rules.

10. The apparatus of claim 1, wherein the one or more reference signal resources are associated with a channel state information (CSI) reference signal (CSI-RS) or synchronization signal block (SSB) resource set, and the CSI-RS or SSB resource set is configured with a single mapping rule for the one or more reference signal resources.

11. The apparatus of claim 1, wherein the one or more reference signal resources are associated with a channel state information (CSI) reference signal (CSI-RS) or synchronization signal block (SSB) resource set, and the CSI-RS or SSB resource set is configured with a plurality of mapping rules for the one or more reference signal resources.

12. An apparatus for wireless communication at a base station, comprising:
a memory; and
one or more processors, coupled to the memory, configured to:
transmit a configuration that includes one or more mapping rules, each of the one or more mapping rules indicating a mapping between one or more reference signal received power (RSRP) measurements, associated with one or more reference signal resources, and one or more indices, associated with one or more feature input vectors for a machine learning model; and
receive an indication of a beam prediction based at least in part on the one or more mapping rules.

13. The apparatus of claim 12, wherein the one or more processors are further configured to transmit a radio resource control message that includes the configuration.

14. The apparatus of claim 12, wherein the one or more processors are configured to transmit a medium access control message or downlink control information that indicates an update to the configuration.

15. The apparatus of claim 12, wherein an output of the machine learning model includes at least one of a beam characteristic or a channel characteristic that is predicted over a time domain, a spatial domain, or a frequency domain.

16. The apparatus of claim 12, wherein an output of the machine learning model includes a prediction of a largest reference signal measurement change, associated with the one or more reference signal resources, for a future time period.

17. The apparatus of claim 12, wherein an output of the machine learning model includes one or more reference signal measurements, associated with the one or more reference signal resources, for a future time window.

18. The apparatus of claim 12, wherein the machine learning model is a long short term memory (LSTM) machine learning model, and wherein an input for the LSTM machine learning model includes a sequence of measured RSRP values.

19. The apparatus of claim 12, wherein the one or more reference signal resources are associated with a channel state information (CSI) reference signal (CSI-RS) or synchronization signal block (SSB) resource set, the CSI-RS or SSB resource set is associated with a CSI report setting, and the CSI report setting includes a single mapping rule.

20. The apparatus of claim 12, wherein the one or more reference signal resources are associated with a channel state information (CSI) reference signal (CSI-RS) or synchronization signal block (SSB) resource set, the CSI-RS or SSB resource set is associated with a CSI report setting, and the CSI report setting includes a plurality of mapping rules.

21. The apparatus of claim 12, wherein the one or more reference signal resources are associated with a channel state information (CSI) reference signal (CSI-RS) or synchronization signal block (SSB) resource set, and the CSI-RS or SSB resource set is configured with a single mapping rule for the one or more reference signal resources.

22. The apparatus of claim 12, wherein the one or more reference signal resources are associated with a channel state information (CSI) reference signal (CSI-RS) or synchronization signal block (SSB) resource set, and the CSI-RS or SSB resource set is configured with a plurality of mapping rules for the one or more reference signal resources

23. A method of wireless communication performed by a user equipment (UE), comprising:
receiving a configuration that includes one or more mapping rules, each of the one or more mapping rules indicating a mapping between one or more reference signal received power (RSRP) measurements, associated with one or more reference signal resources, and one or more indices, associated with one or more feature input vectors for a machine learning model; and
initiating a beam prediction based at least in part on the one or more mapping rules.

24. The method of claim 23, wherein the receiving the configuration comprises receiving a radio resource control message that includes the configuration.

25. The method of claim 23, wherein receiving the configuration comprises receiving a medium access control message or downlink control information that indicates an update to the configuration.

26. The method of claim 23, wherein an output of the machine learning model includes at least one of a beam characteristic or a channel characteristic that is predicted over a time domain, a spatial domain, or a frequency domain.

27. The method of claim 23, wherein an output of the machine learning model includes a prediction of a largest reference signal measurement change, associated with the one or more reference signal resources, for a future time period.

28. The method of claim 23, wherein an output of the machine learning model includes one or more reference signal measurements, associated with the one or more reference signal resources, for a future time window.

29. The method of claim 23, wherein the machine learning model is a long short term memory (LSTM) machine learning model, and wherein an input for the LSTM machine learning model includes a sequence of measured RSRP values.

30. A method of wireless communication performed by a base station, comprising:
transmitting a configuration that includes one or more mapping rules, each of the one or more mapping rules indicating a mapping between one or more reference signal received power (RSRP) measurements, associated with one or more reference signal resources, and one or more indices, associated with one or more feature input vectors for a machine learning model; and
receiving an indication of a beam prediction based at least in part on the one or more mapping rules.

31. The method of claim 30, wherein the transmitting the configuration comprises transmitting a radio resource control message that includes the configuration.

32. The method of claim 30, wherein transmitting the configuration comprises transmitting a medium access control message or downlink control information that indicates an update to the configuration.

33. The method of claim 30, wherein an output of the machine learning model includes at least one of a beam characteristic or a channel characteristic that is predicted over a time domain, a spatial domain, or a frequency domain.

34. The method of claim 30, wherein an output of the machine learning model includes a prediction of a largest reference signal measurement change, associated with the one or more reference signal resources, for a future time period.

35. The method of claim 30, wherein an output of the machine learning model includes one or more reference signal measurements, associated with the one or more reference signal resources, for a future time window.
